(19) United States
(12) Patent Application Publication
(10) Pub. No.: US 2006/0233576 A1
(43) Pub. Date: Oct. 19, 2006

(54) Multi-function printer having compact structure

(75) Inventors: Young-min Kim, Suwon-si (KR); Sang-cheol Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/284,950

(22) Filed: Nov. 23, 2005

(30) Foreign Application Priority Data
Apr. 16, 2005 (KR) 2005-31709

(51) Int. Cl. G03G 15/00

(52) U.S. Cl. 399/361

(57) ABSTRACT

A multi-functional printer having a compact structure including a feeder for supplying paper; an image forming part for forming an image on the paper supplied from the feeder; a paper discharge part for discharging the paper passing though the image forming part; an image reading part for communicating data with the image forming part; a controller for controlling operation of the feeder, the image forming part, the paper discharge part and the image reading part; and a housing for accommodating and supporting the image forming part, the paper discharge part and the image reading part, wherein the housing includes a paper inlet formed corresponding to the feeder and partially inserted with the paper, and a paper outlet formed corresponding to the paper discharge part, and the image reading part further comprises an image reading table having a scan area with a size smaller then a size of a predetermined standard paper.

### CROSS-REFERENCE TO RELATED APPLICATIONS

This application claims priority from Korean Patent Application No. 2005-31709, filed on Apr. 16, 2005 in the Korean Intellectual Property Office, the disclosure of which is incorporated herein by reference.

### BACKGROUND OF THE INVENTION

1. Field of the Invention

Aspects of the present invention relate to a multi-function printer and, more particularly, to a multi-function printer having a compact structure.

2. Description of the Related Art

Referring to FIG. 1, a conventional multi-function printer 100 includes a feeder 110 supplying paper 1, an image forming part 120 to form an image on the paper 1 received from the feeder 110, a paper discharge part 130 to discharge the paper 1 formed with the image, an image reading part 140 to read a document and transfer image data from the document to the image forming part 120 and a housing 101 to accommodate and support the foregoing elements. A feed cassette 111 mounted to the feeder 110 is designed to accept a large sized paper (e.g., a legal sized paper), so as to accommodate various sized paper up to and including the large sized paper. The image reading part 140 includes an image reading table 142 of a flatbed type as well as an automatic document feeder (ADF) 141. The image reading table 142 is also designed to accept a large sized paper like the feed cassette 111. A document holding tray 102 holds the paper 1 that has been discharged. With the conventional multi-function printer 100, the feed cassette 111 and the image reading part 140 take up a lot of space, thereby needing plenty of installation space.

Another conventional multi-function printer 200 configuration is shown in FIGS. 2A and 2B. In this configuration, a direction where a feed cassette 210 is mounted to a main body 220 is perpendicular to a direction where an image reading part 230 is mounted to the main body 220. In this case, the feed cassette 210 and the image reading part 230 are respectively designed to hold the legal sized paper, so that an upper part of the main body 220 and a lower part of the main body 220 respectively have a structure which is projected in a right/left direction and in a forward/backward direction. Therefore, an entire size of the multi-function printer 200 is still big.

### SUMMARY OF THE INVENTION

Accordingly, it is an aspect of the present invention to provide a multi-function printer having a compact structure and reducing sizes of an image reading part and a feeder. Particularly, it is an aspect of the present invention to provide a multi-function printer suitable for use by an individual in a small space.

Further, it is an aspect of the present invention to provide a multi-function printer which decreases a cost of production and expense of physical distribution by reducing an entire size of the printer.

The foregoing and/or other aspects of the present invention can be achieved by providing a multi-function printer, comprising: a feeder to supply paper; an image forming part to form an image on the paper supplied from the feeder; a paper discharge part to discharge the paper passing though the image forming part; an image reading part to communicate data with the image forming part; a controller to control operation of the feeder, the image forming part, the paper discharge part and the image reading part; and a housing accommodating and supporting the image forming part, the paper discharge part and the image reading part, wherein the housing includes a paper inlet formed corresponding to the feeder and the paper being partially inserted in the feeder, and a paper outlet formed corresponding to the paper discharge part, and the image reading part further comprises an image reading table having a scan area with a size smaller than a size of a predetermined standard paper.

According to an aspect of the present invention, a planar area which the image reading part occupies exists within the largest planar area which the housing occupies.

According to an aspect of the present invention, the image reading part further comprises an automatic document feeder (ADF).

According to an aspect of the present invention, the feeder further comprises a loading part to load the paper and a feed cassette inserted and detached through the paper inlet.

According to an aspect of the present invention, the multi-function printer further comprises a supporting tray detachably mounted to the housing to support the paper loaded on the feeder, formed corresponding to the paper inlet.

According to an aspect of the present invention, the supporting tray is hinge-coupled to the housing and is foldable onto the housing.

According to an aspect of the present invention, the supporting tray further comprises a slidable extending member.

According to an aspect of the present invention, the multi-function printer further comprises a holding tray detachably mounted to the housing to hold the paper discharged from the paper discharge part, formed corresponding to the paper outlet.

According to an aspect of the present invention, the holding tray is hinge-coupled to the housing and is foldable onto the housing.

According to an aspect of the present invention, the holding tray further comprises an extending member coupled to be slidable.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a front view illustrating an embodiment according to a conventional multi-function printer;

FIGS. 2A and 2B are a front view and a side view illustrating another embodiment according to a conventional multi-function printer;

FIG. 3 is a side view illustrating a multi-function printer according to an embodiment of the present invention;

FIG. 4 is a side view illustrating a multi-function printer according to another embodiment of the present invention; and

FIG. 5 is a partial view illustrating a modified embodiment of FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

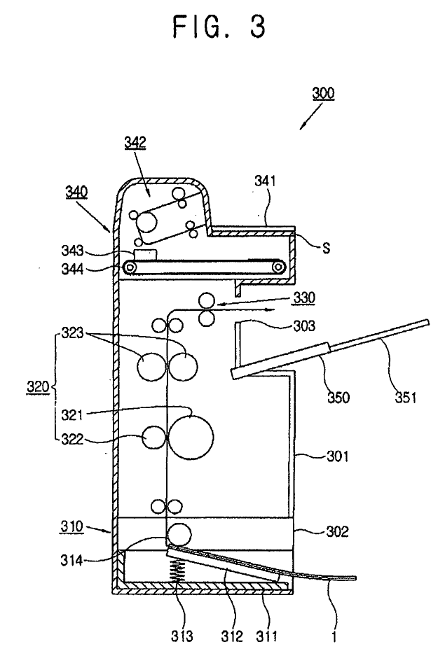

Referring to FIG. 3, a multi-function printer 300 according to a first embodiment of the present invention includes a feeder 310 mounted to the lowermost part thereof to supply paper 1, an image forming part 320 to form an image on the paper 1 supplied from the feeder 310, a paper discharge part 330 to discharge the paper 1 passing through the image forming part 320, an image reading part 340 to communicate data with the image forming part 320 and a housing 301 to accommodate and support foregoing elements thereof. Further, the multi-function printer 300 comprises a controller (not shown) which controls operation of the feeder 310, the image forming part 320, the paper discharge part 330, and the image reading part 340.

The components of the multi-function printer 300 include the feeder 310, the image forming part 320, the paper discharge part 330, and the image reading part 340 that are stacked vertically in turn, to thereby minimize an area that the multi-function printer 300 occupies on a plane surface. Further, the housing 301 minimizes a necessary horizontal space for installing the image forming part 320. Therefore, according to aspects of the present invention, only part of the paper 1 (e.g., A4 paper), which is stacked on the feeder 310, is inserted into the feeder 310 as shown therein, and a holding tray 350 for catching the paper discharged from the paper discharge part 330 is not formed as an integral part of the housing 301.

The housing 301 is provided with a paper inlet 302 corresponding to the feeder 310, and a paper outlet 303 corresponding to the paper discharge part 330. The paper 1 is supplied to the paper inlet 302 and is stacked on the feeder 310, and the paper 1 discharged from the paper discharge part 330 is discharged via the paper outlet 303 to the outside where it may be stacked on the holding tray 350.

The feeder 310 comprises a knock-up plate 312 in which the paper 1 is stacked, and a feed cassette 311 mounted inside the housing 301 so as to be detachable through the paper inlet 302. When the feed cassette 311 is mounted to the feeder 310, the feed cassette 311 is not projected outside the housing 301. A side of the feed cassette 311 is opened, and in case where the paper 1 is longer than the feed cassette 311, a portion of the paper 1 is projected from the feed cassette 311 as shown therein.

The paper 1 stacked on the knock-up plate 312 is pressed in an upward direction by a spring 313 and is picked up sheet by sheet by a pick-up roller 314 and then the paper 1 is carried to the image forming part 320. The image forming part 320 is provided with an Organic Photo Conductor (OPC) drum 321 and a transfer roller 322 which form a toner image on the transferred paper. The image forming part 320 is provided with a fix roller 323 which fixes the toner image on the paper 1. The paper 1, which has the toner image fixed to the paper 1 at the image forming part 320, is carried to the paper discharge part 330, and then is discharged via the paper outlet 303 to the outside.

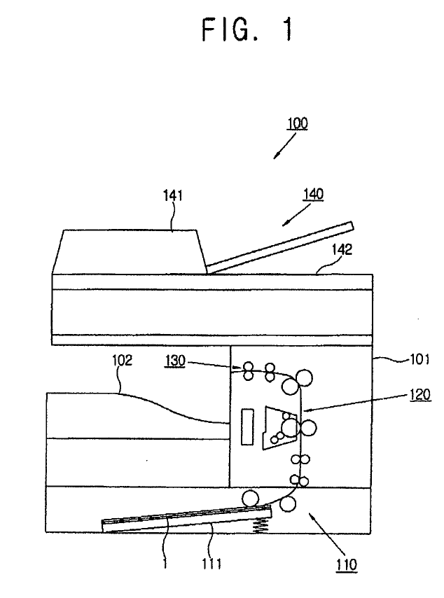

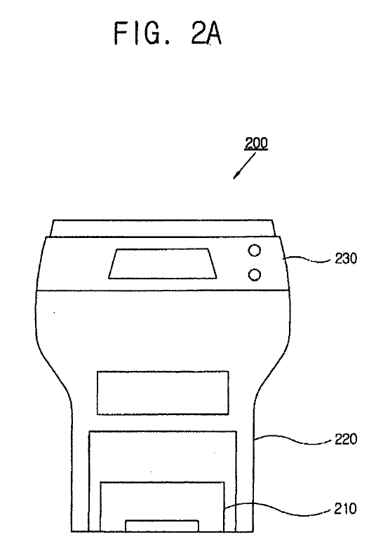

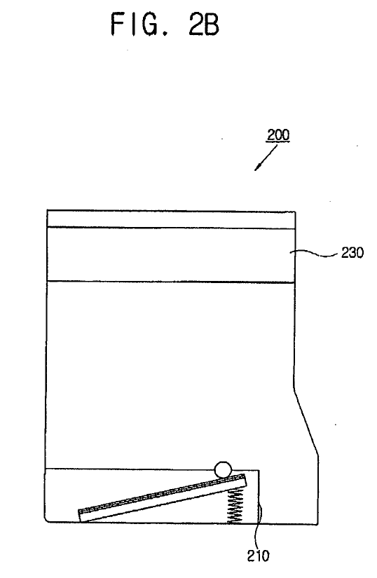

The housing 301 is not separately provided with a paper stack part 102 illustrated in FIG. 1 for stacking the discharged paper in the structure. Therefore, the housing 301 may be separately provided with the holding tray 350 to be mountable to the housing 301 and for holding the discharged paper. The holding tray 350 may be hinge-coupled to the housing 301. The holding tray 350 may be separated from the housing 301 or may be rotated and folded onto the housing 301 when not in use. Further, an extending member 351 may be slidably coupled to the loading tray 350 and may be used to extend a length of the holding tray 350 as necessary.

The image reading part 340 is mounted to an upper part of the paper discharge part 330. The image reading part 340 includes an image reading table 341 having a scan area (S) for accommodating and reading the document an upper surface thereof. An image reading unit 343 and a driving unit 344 for reciprocating the image reading unit 343 to the scan area (S) is housed in the image reading part 340. A side of an upper part of the image reading part 340 is provided with an Automatic Document Feeder (ADF) 342 to automatically pass the document used as a reading subject to the image reading unit 343. The structure of the image reading table 341 and the ADF 342 is well known to one of ordinary skill in the art.

Meanwhile, a horizontal area of the image reading table 341 is similar to or smaller than a horizontal area of the housing 301 so as to minimize an installation space of the multi-function printer 300. Therefore, the image reading table 341, which conventionally required a large space due to a structure of the conventional multi-function printer, is reduced in an embodiment of the present invention illustrated in FIG. 3, thereby minimizing the required installation space of the multi-function printer 300. However, the size of the document accommodated in the image reading table 341 is limited by the reduced size, but it can be complemented by the ADF 342 which permits larger sized documents to be accepted and scanned.

That is, the document which is not fully accommodated at the image reading table 341 is read by the ADF 342, and a document of a small size such as a book is read by the image reading table 341. If the book uses A5 sized standard paper, the scan area (S) of the image reading table 341 can be manufactured to accept the A5 sized standard paper. The paper being bound in a book makes using the ADF 342 impossible, so that it is appropriate to use the image reading table 341 having the suitable size. The smaller the size of the image reading table 341 is made, the smaller the scan area (S) becomes. Therefore, a moving time of the image reading unit 343 reciprocating the scan area (S) becomes shortened, thereby improving a scan speed.

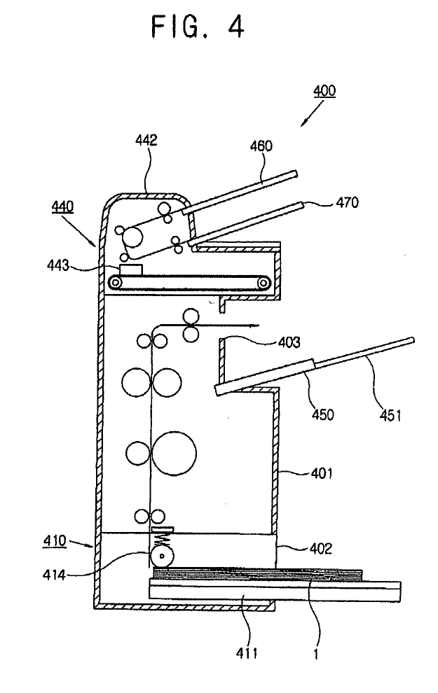

The ADF 342 of the image reading part 340 may comprise a loading tray having a structure similar to the holding tray 350, mounted to a side of the paper outlet 303 of the housing 301, which supports the paper carried to the image reading unit 343 and/or the paper discharged from the image reading unit 343. In another embodiment the ADF 342 may comprise two loading trays configured as shown by elements 460 and 470 in FIG. 4.

FIG. 4 is a side view illustrating another embodiment of a multi-function printer according to the present invention. The multi-function printer 400 is not provided with a feed cassette 311, illustrated in FIG. 3, which is inserted and detached to a paper inlet 402. Rather, a supporting tray 411 is partially inserted in the paper inlet 402. The paper 1 is stacked on the supporting tray 411 with a portion of the paper 1 remaining outside the paper inlet 402. Feeding of the paper 1 at a feeder 410 is accomplished by a pick-up roller 414, which elastically presses downward on the paper 1.

A first loading tray 450 is detachably mounted to a side of a housing 401 where a paper outlet 403 is disposed, and holds the paper which is discharged from the paper outlet 403. An ADF 442 of an image reading part 440 is provided with a second loading tray 460 detachably mounted thereto. The ADF 442 loads the paper 1 from the second loading tray 460 to supply the paper 1 to an image reading unit 443 which is accommodated and supported therein. The ADF 442 includes a supporting tray 470 for supporting the paper 1 passing through the image reading unit 443. The second loading tray 460 and the supporting tray 470, and the first loading tray 450 mounted to the side of the housing 401 may be respectively hinge-coupled to the ADF 44 or the housing 401, so that when not in use, they may be separated for storage. The first loading tray 450 coupled to the housing 401 may be folded onto the housing 301.

An extending member 451 may be slidably coupled to the first loading tray 450 and may be used to extend the effective length of the first loading tray 450 as necessary. Such a structure may also be applied to the second loading tray 460 mounted to the ADF 442 and the supporting tray 470.

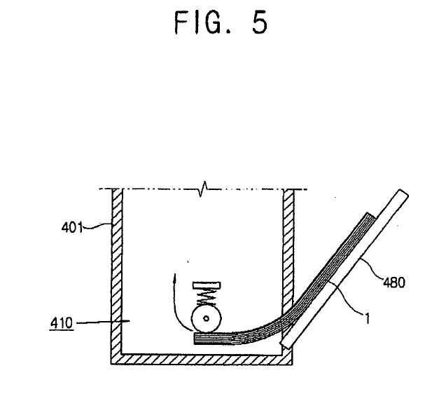

Meanwhile, referring to FIG. 5, the supporting tray 480 for supporting the paper 1 supplied to the feeder 410 is detachably coupled to the housing 401 with a slope of a predetermined angle, thereby easily supplying the paper 1. The supporting tray 480 is coupled to the housing 401, and the extending member 451 is slidably coupled thereto. The supporting tray 480 may be folded along the housing 401 for storage, usually with the extending member 451 in the retracted position.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A multi-function printer, comprising:
a feeder to supply paper;
an image forming part to form an image on the paper supplied from the feeder;
a paper discharge part to discharge the paper passing though the image forming part;
an image reading part to scan data;
a controller to control operation of the feeder, the image forming part, the paper discharge part and the image reading part; and
a housing accommodating and supporting the image forming part, the paper discharge part and the image reading part in a vertical stack, wherein the housing includes a paper inlet formed corresponding to the feeder and the paper being partially inserted into the feeder, and a paper outlet formed corresponding to the paper discharge part, and
the image reading part further comprises an image reading table having a scan area with a size smaller than a size of a predetermined standard paper.

2. The multi-function printer according to claim 1, wherein a planar area which the image reading table occupies exists within the largest planar area which the housing occupies.

3. The multi-function printer according to claim 1, wherein the image reading part further comprises an automatic document feeder (ADF).

4. The multi-function printer according to claim 1, wherein the feeder further comprises a loading part to load the paper and a feed cassette inserted and detached through the paper inlet.

5. The multi-function printer according to claim 1, further comprising a supporting tray detachably mounted to the housing to support the paper loaded in the feeder, formed corresponding to the paper inlet.

6. The multi-function printer according to claim 5, wherein the supporting tray is hinge-coupled to the housing and is foldable onto the housing.

7. The multi-function printer according to claim 5, wherein the supporting tray further comprises a slidable extending member.

8. The multi-function printer according to claim 1, further comprising a holding tray detachably mounted to the housing to hold the paper discharged from the paper discharge part, formed corresponding to the paper outlet.

9. The multi-function printer according to claim 8, wherein the holding tray is hinge-coupled to the housing and is foldable onto the housing.

10. The multi-function printer according to claim 8, wherein the holding tray further comprises a slidable extending member.

11. A small footprint multi-function image forming apparatus, comprising:
a detachable tray supporting print media; and
a housing configured to support in a vertical orientation from bottom to top,
a feeder configured to receive the print media;
a pickup roller assembly configured to pick-up and feed each sheet of the print media stacked on the feeder for an image forming operation;
an image forming assembly configured to impart a toner image on each sheet of print media; and
an image scanning assembly configured to scan a document and convert the scanned document to digital data,
wherein the detachable tray is inserted partly into the feeder to supply the print media, and a portion of the detachable tray remains outside a footprint of the housing.

12. The image forming apparatus of claim 11, wherein a planar scanning area of the image scanning assembly is fully contained within the footprint of the housing.

13. The image forming apparatus of claim 11, wherein the image scanning assembly further comprises an automatic document feeder (ADF).

14. The image forming apparatus of claim 11, wherein the detachable tray is connected with the housing via a hinge so that when the image forming apparatus is not in use the detachable tray is rotatable about the hinge to become flush with the housing.

15. The image forming apparatus of claim 11, wherein the detachable tray comprises a frame to be slideably coupled to the housing, a plate to support the print media within the frame such that the pickup roller assembly sequentially drawing pieces of the print media into the image forming appartatus.

16. The image forming apparatus of claim 11, further comprising:
a holding tray detachably coupled with the housing to hold the print media discharged from the image forming assembly.

17. The image forming apparatus of claim 16, wherein the holding tray is connected with the housing via a hinge so that when the image forming apparatus is not in use the holding tray is rotatable about the hinge to become flush with the housing.

18. The image forming apparatus of claim 16, wherein the holding tray includes a slidable member to extend an effective length of the holding tray according to a size of the print media.

19. A small footprint multi-function image forming apparatus, comprising:
a paper feeding cassette having a knock-up plate arranged to support print media and to rotate about a distal end in an upward/downward direction, and a bias member arranged to lift the knock-up plate in an upward direction; and
a housing configured to support in a vertical orientation from bottom to top,
a feeder configured to receive the print media;
a pickup roller assembly contacting the print media stacked on the feeder to lift and feed each sheet of the print media for an image forming operation;
an image forming assembly configured to impart a toner image on each sheet of print media received from the pickup roller; and
an image scanning assembly configured to scan a document and convert the scanned document to digital data,
wherein the paper feeding cassette is contained within a footprint of the housing, and the print media is partially on the paper feeding cassette and partially protrudes outside the footprint of the housing.

20. The image forming apparatus of claim 19, further comprising:
a holding tray detachably coupled with the housing to hold the print media discharged from the image forming assembly.
